(19) United States
(12) Patent Application Publication
(10) Pub. No.: US 2008/0101516 A1
(43) Pub. Date: May 1, 2008

(54) SYNCHRONIZATION DEVICE AND METHOD FOR WIRELESS COMMUNICATION PACKETS

(75) Inventors: Koon Shik Cho, Seoul (KR); Seung Han Ko, Seongnam (KR); Jae Hyung Lee, Suwon (KR); Kwang Mook Lee, Seoul (KR); Sang Hyun Min, Yongin (KR); Sang Ho Lee, Suwon (KR); U Sang Lee, Hwaseong (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/925,121

(22) Filed: Oct. 26, 2007

(30) Foreign Application Priority Data
Oct. 27, 2006 (KR) 10-2006-0104808

(51) Int. Cl. H04L 7/02

(52) U.S. Cl. 375/359

(57) ABSTRACT

Provided is a synchronization device for wireless communication packets, the synchronization device including an A/D (analog/digital) converter that converts an analog input signal applied from outside into a digital signal; a correlation calculating section that is connected to the A/D converter and correlates the converted input signal with a preset reference code so as to calculate a correlation value; a threshold setting section that is connected to the correlation calculating section and sets a threshold value of the correlation value; a maximum correlation detecting section that is connected to the correlation calculating section and the threshold setting section, compares the correlation value with the threshold value, detects the position of the maximum correlation value within each symbol of the input signal when the correlation value is larger than the threshold value, and judges whether a difference in position between the maximum correlation values of consecutive symbols is equal to the period of one symbol or not; a preamble detecting section that is connected to the correlation calculating section and the maximum correlation detecting section and outputs a preamble detection signal when the difference is equal to the period of one symbol; and a data detecting section that receives data of the input signal when the preamble detection signal is applied.

### CROSS-REFERENCE TO RELATED APPLICATIONS

This application claims the benefit of Korean Patent Application No. 10-2006-0104808 filed with the Korea Industrial Property Office on Oct. 27, 2006, the disclosure of which is incorporated herein by reference.

### BACKGROUND OF THE INVENTION

1. Field of the Invention

The present invention relates to a synchronization device and method for wireless communication packets, which compares the maximum correlation values of respective symbols of an input signal so as to synchronize packets.

2. Description of the Related Art

Recently, researches on communication networks such as a WLAN (Wireless LAN), a WPAN (Wireless Personal Area Network), a ubiquitous sensor network, RFID (Radio Frequency Identification) as well as a cellular network are being carried out.

In the WPAN or ubiquitous sensor network, there is a demand for reduction in size, a low price, low power consumption as well as communication performance. Accordingly, a technique used in the cellular communication system and a high-performance system are required.

Hereinafter, a conventional synchronization device and method for wireless communication packets will be described in detail with reference to accompanying drawings.

FIG. 1 is a block diagram of a conventional synchronization device for wireless communication packets. FIG. 2 is a flow chart sequentially showing a conventional synchronization method for wireless communication packets.

First, as shown in FIG. 1, the conventional synchronization device for wireless communication packets includes an A/D (analog/digital) converter 110, a correlation calculating section 120, a threshold setting section 130, a correlation determining section 140, a preamble detecting section 150, and a data detecting section 160.

The A/D converter 110 is connected to the correlation calculating section 120 and the data detecting section 160 and converts an analog input signal S, applied from outside, into a digital signal to output.

The correlation calculating section 120 is connected to the threshold setting section 130, the correlation determining section 140, and the preamble detecting section 150 and correlates the input signal S, converted by the A/D converter 110, with a preset reference code so as to calculate a correlation value. At this time, the reference code correlated with the input signal S is set to a code which is previously determined for communication by an agreement between users.

The threshold setting section 130 sets a threshold value of the correlation value calculated by the correlation calculating section 120, the threshold value representing a value for judging whether the input signal S is a signal to be transmitted or noise.

The correlation determining section 140 is connected to the correlation calculating section 120 and the threshold setting section 130 and compares the correlation value, calculated by the correlation calculating section 120, with the threshold value set by the threshold setting section 130.

The preamble detecting section 150 is connected to the correlation calculating section 120 and the threshold setting section 130. When the correlation value is larger than the threshold value, the preamble detecting section 150 judges that the input signal S is a signal to be transmitted, and starts to detect a preamble included in the input signal S. When the preamble is detected, the preamble detecting section 150 outputs a preamble detection signal P.

When the correlation value is smaller than the threshold value, the preamble detecting section 150 judges that the input signal S is noise, and discards the correlation value. Then, a correlation value which is subsequently applied is compared with the threshold value.

The data detecting section 160, to which the preamble detection signal P is applied from the preamble detecting section 150, receives the input signal S, applied from the A/D converter, from when the preamble detection signal P is applied. Then, the data detecting section 160 synchronizes packets, thereby receiving data to be transmitted.

Now, the synchronization method for wireless communication packets will be described with reference to FIG. 2.

First, as shown in FIG. 2, a threshold value is set (step S201).

Then, an analog input signal applied from outside is converted into a digital signal (step S202).

The converted input signal is correlated with a preset reference code so as to calculate a correlation value (step S203).

The correlation value calculated at step S203 is compared with the threshold value set at step S201 so as to judge whether the correlation value is larger than the threshold value or not (step S204).

At this time, when the correlation value is larger than the threshold value, it is judged that the input signal is a signal transmitted for wireless communication, and a preamble is detected. When the preamble is detected, a preamble detection signal is generated (step S205).

Otherwise, when the correlation value is smaller than the threshold value, it is judged that the input signal is noise, and the correlation value is discarded. Then, the process is fed back to step S203, and the input signal is again correlated with the reference code.

From a point of time where the preamble detection signal for synchronizing packets is generated in step S205, data of the input signal is applied (step S206).

However, when the threshold value is set to a small value, noise is detected as a packet. Further, the noise which is not a signal to be transmitted is received as data such that a packet loss occurs. On the contrary, when the threshold value is increased, sensitivity is reduced, even though the phenomenon where noise is detected as a packet is reduced.

### SUMMARY OF THE INVENTION

An advantage of the present invention is that it provides a synchronization device and method for wireless communication packets, which compares the maximum correlation values of respective symbols of an input signal and synchronizes packets when a difference in position between the maximum correlation values is equal to the period of one symbol, thereby reducing a packet loss and enhancing sensitivity.

Additional aspect and advantages of the present general inventive concept will be set forth in part in the description which follows and, in part, will be obvious from the description, or may be learned by practice of the general inventive concept.

According to an aspect of the invention, a synchronization device for wireless communication packets comprises an A/D (analog/digital) converter that converts an analog input signal applied from outside into a digital signal; a correlation calculating section that is connected to the A/D converter and correlates the converted input signal with a preset reference code so as to calculate a correlation value; a threshold setting section that is connected to the correlation calculating section and sets a threshold value of the correlation value; a maximum correlation detecting section that is connected to the correlation calculating section and the threshold setting section, compares the correlation value with the threshold value, detects the position of the maximum correlation value within each symbol of the input signal when the correlation value is larger than the threshold value, and judges whether a difference in position between the maximum correlation values of consecutive symbols is equal to the period of one symbol or not; a preamble detecting section that is connected to the correlation calculating section and the maximum correlation detecting section and outputs a preamble detection signal when the difference is equal to the period of one symbol; and a data detecting section that receives data of the input signal when the preamble detection signal is applied.

Preferably, the maximum correlation detecting section increases a count value by 1, when a difference in position between the maximum correlation values of a current symbol and a next symbol is equal to the period of one symbol.

Preferably, when the count value is equal to the preset symbol-period count value, the preamble detecting section operates to detect a preamble and outputs a preamble detection signal when the preamble is detected.

Preferably, when the difference in position between the maximum correlation values of the current symbol and the next symbol is not equal to the period of one symbol, the maximum correlation detecting section sets the count value to 0 and then increases the count value on the basis of the next symbol.

According to another aspect of the invention, a synchronization method for wireless communication packets comprises the steps of: (a) setting a threshold value and a symbol-period count value; (b) converting an analog input signal, applied from outside, into a digital signal; (c) correlating the converted input signal with a preset reference code so as to calculate a correlation value; (d) comparing the calculated correlation value with the threshold value, detecting the maximum correlation value of a current symbol of the input signal when the correlation value is larger than the threshold value, and storing the position of the maximum correlation value; (e) detecting the maximum correlation value of a next symbol of the input signal and storing the position of the maximum correlation value; (f) judging whether or not a difference in position between the maximum correlation values of the next symbol and the current symbol is equal to the period of one symbol; (g) when it is judged at step (f) that the difference is equal to the period of one symbol, increasing the count value by 1; and (h) judging whether or not the increased count value is equal to the symbol-period count value set at step (a), detecting a preamble to generate a preamble detection signal when the count value is equal to the symbol-period count value, and receiving data included in the input signal.

Preferably, when the calculated correlation value is smaller than the threshold value at step (d), the process is fed back to step (c).

Preferably, when it is judged at step (f) that the difference in position between the maximum correlation values of the next symbol and the current symbol is not equal to the period of one symbol, the process is fed back to step (d). When the process is fed back to step (d), the count value is set to 0. After the process is fed back to step (d), the position of the maximum correlation value of a symbol, applied after the next symbol, is compared with the position of the maximum correlation value of the next symbol.

Preferably, when it is judged at step (h) that the count value is not equal to the symbol-period count value, the process is fed back to step (d) and is then repeated.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a conventional synchronization device for wireless communication packets;

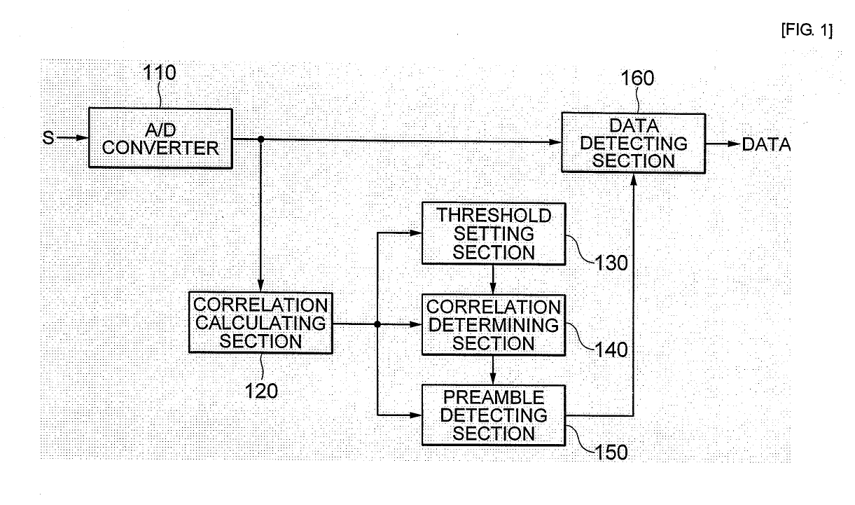

FIG. 2 is a flow chart sequentially showing a conventional synchronization method for wireless communication packets;

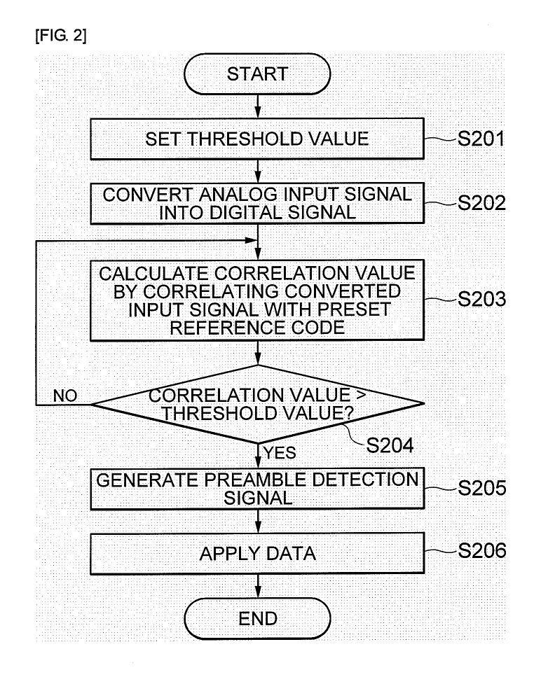

FIG. 3 is a block diagram of a synchronization device for wireless communication packets according to the invention;

FIG. 4 is a diagram schematically showing a method of comparing the maximum correlation values of symbols according to the invention; and

FIG. 5 is a flow chart sequentially showing a synchronization method for wireless communication packets according to the invention.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Hereinafter, a synchronization device for wireless communication packets according to an embodiment of the present invention will be described in detail with reference to the accompanying drawings.

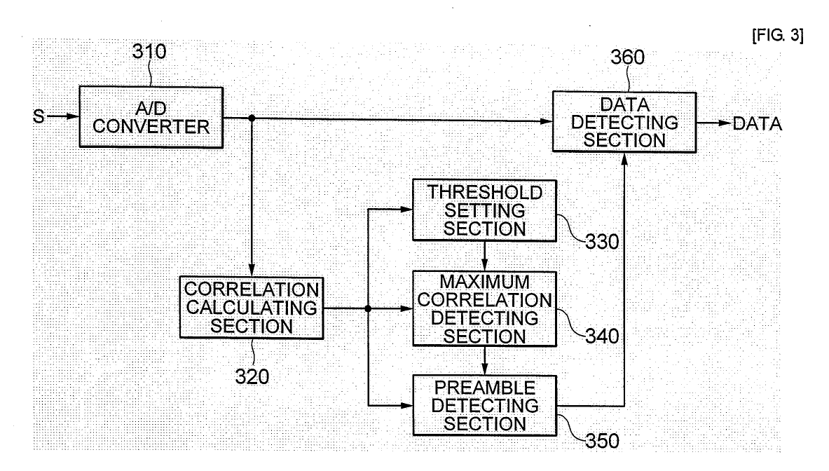

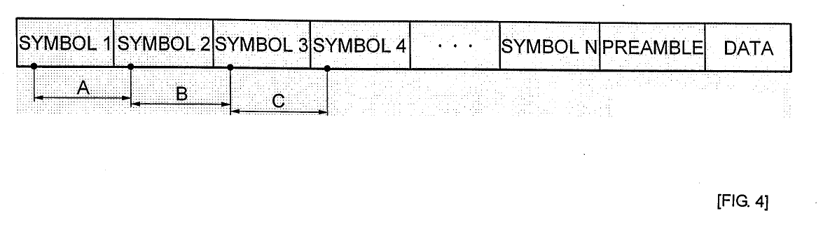

FIG. 3 is a block diagram of a synchronization device for wireless communication packets according to the invention. FIG. 4 is a diagram schematically showing a method of comparing the maximum correlation values of symbols according to the invention.

As shown in FIG. 3, the synchronization device for wireless communication packets according to the invention includes an A/D converter 310, a correlation calculating section 320, a threshold setting section 330, a maximum correlation detecting section 340, a preamble detecting section 350, and a data detecting section 360.

The A/D converter 310 is connected to the correlation calculating section 320 and the data detecting section 360 and converts an analog input signal S, applied from outside, into a digital signal to output.

The correlation calculating section 320, which is connected to the A/D converter 310, the threshold setting section 330, the maximum correlation detecting section 340, and the preamble detecting section 350, serves to calculate a correlation value by correlating the input signal S, converted by the A/D converter 310, with a preset reference code.

At this time, the input signal S is composed of a plurality of symbols and data. Each of the symbols is correlated with the reference code, thereby having a correlation value. Here, the reference code is set to a code which is previously determined for communication by an agreement between users.

The threshold setting section 330, which is connected to the correlation calculating section 320 and the maximum correlation detecting section 340, serves to set a threshold value which is a reference value to the correlation value so as to judge whether the input signal S is a signal to be transmitted or noise.

The maximum correlation detecting section 340 compares the correlation value calculated by the correlation calculating section 320 with the threshold value, and then operates when the correlation value is larger than the threshold value.

If the correlation value is larger than the threshold value, the maximum correlation detecting section 340 detects the position of the maximum correlation value of each symbol in the input signal S and then stores the detected position. At this time, as shown in FIG. 4, the plurality of symbols are continuously applied, and the correlation calculating section 320 calculates correlation values by respectively correlating the symbols 1 to N with the reference code.

That is, when the correlation value of the input signal S is larger than the threshold value, the maximum correlation detecting section 340 detects the maximum correlation value within the symbol 1 of the input signal S, which is firstly applied, and then stores the position thereof. Further, the maximum correlation detecting section 340 detects the maximum correlation value within the symbol 2 of the input signal S, which is secondly applied, and then stores the position thereof.

Then, the stored position of the maximum correlation value of the symbol 1 is subtracted from the stored position of the maximum correlation value of the symbol 2 so as to obtain a difference A therebetween. When the obtained difference A in position between the maximum correlation values of the symbols 1 and 2 is equal to the period of one symbol, a count value is increased by 1.

In this case, the count value represents a value obtained by counting whether or not a difference in position between the maximum correlation values of a currently detected symbol and a next symbol is equal to the period of one symbol. The count value is compared with a symbol-period count value which is previously set to a predetermined value by a user, and an initial count value is set to 0.

As the difference in position between the maximum correlation values of the symbols 2 and 1 is equal to the period of one symbol, it can be judged that a normal signal is applied, because if the input signal S is a normal signal, the maximum correlation values of the respective symbols in the input signal are regularly positioned. In this case, however, the difference in position may be equal to the period of one symbol by accident. Therefore, the counting is not performed only one time, but is performed by the number of times corresponding to the symbol-period count value such that a loss caused by noise can be reduced.

When the difference in position between the maximum correlation values of the symbols 2 and 1 is equal to the period of one symbol, the count value is increased by 1. Then, when the increased count value is not equal to the preset symbol-period count value, the maximum correlation value of the symbol 3 is detected, and the position thereof is stored. In this case, since the symbol-period count value serves to limit the count value, it can be set depending on a user.

Next, a difference B in position between the maximum correlation values of the symbols 3 and 2 is calculated, and it is judged whether the difference B is equal to the period of one symbol or not.

At this time, when the difference B in position between the maximum correlation values of the symbols 3 and 2 is equal to the period of one symbol, the count value is increased by 1. Then, the increased count value is compared with the preset symbol-period count value. When the increased count value is not equal to the symbol-period count value, the maximum correlation value of a symbol 4, which is subsequently applied, is detected, and the position thereof is stored.

If the symbol-period count value is previously set to 2 and the increased count value is equal to the symbol-period count value, it is judged that the input signal S is a normal signal to be transmitted.

At this time, since it is judged that the input signal S is a normal signal to be transmitted, the preamble detecting section 350 does not perform the calculation of correlation value from the symbols 4 to N, but searches for a preamble until the preamble is applied. When the preamble is applied while such a process is performed, the preamble detecting section 350 generates a preamble detection signal P, which informs that the preamble is applied, and then applies the preamble detection signal P to the data detecting section 360.

The data detecting section 360, to which the preamble detection signal P is applied, receives the input signal S from when the preamble detection signal P is applied, and then synchronizes packets. Accordingly, the data detection section 360 receives data, which is included in the input signal S and is to be transmitted.

Meanwhile, when the difference in position between the maximum correlation values of the symbols 3 and 2 is not equal to the period of one symbol, it is judged that the input signal S is not a signal to be transmitted, and the count value is substituted with 0. Then, the maximum correlation value of the symbol 4 is detected, and the position thereof is stored.

At this time, a sliding window scheme is used, in which the position of the maximum correlation value of the symbol 4 is not compared with the position of the maximum correlation value of a symbol 5 which is subsequently applied, but is compared with the position of the maximum correlation value of the previous symbol 3. Therefore, it can be effectively used for a signal with an insufficient number of symbols.

After the positions of the maximum correlation values of the symbols 4 and 3 are compared, the same process as the above-described process is performed so as to search for a point of time where the count value is equal to the preset symbol-period count value.

In the synchronization device for wireless communication packets, the correlation value of the input signal S and the threshold value are simply compared with each other. When the correlation value is larger than the threshold value, packets are synchronized by judging whether a difference in position between the maximum correlation values of the respective symbols is equal to the period of one symbol. Therefore, a loss generated by noise can be reduced into 0.3% from 12%, compared with the conventional synchronization device. Accordingly, sensitivity is enhanced.

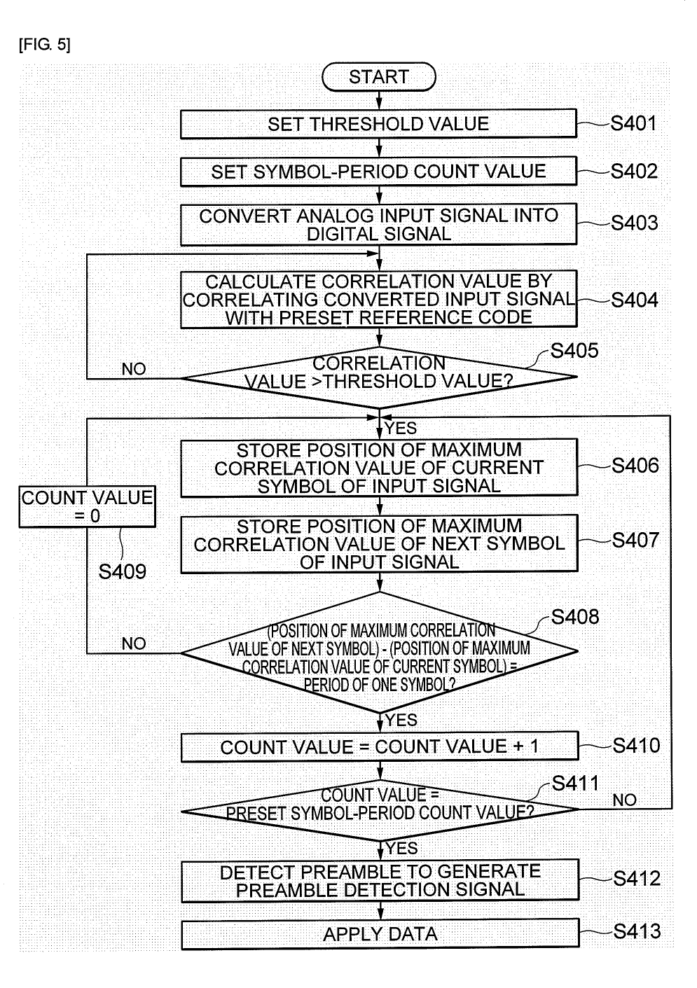

Hereinafter, a synchronization method for wireless communication packets according to the invention will be described with reference to FIG. 5.

FIG. 5 is a flow chart sequentially showing a synchronization method for wireless communication packets according to the invention.

First, as shown in FIG. 5, a threshold value is set, which represents a threshold limit with respect to a correlation value of an input signal (step S401).

Then, a symbol-period count value is set, which represents the number of comparisons between symbols of the input signal (step S402).

After the threshold value and the symbol-period count value are set, an analog input signal applied from outside is converted into a digital signal to output (step S403).

The digital input signal converted at step S403 is correlated with a preset reference code so as to calculate a correlation value (step S404).

The correlation value calculated at step S404 and the threshold value set at step S401 are compared with each other so as to judge whether the correlation value is larger than the threshold value (step S405).

At this time, when it is judged that the correlation value is smaller than the threshold value, it is judged that the input signal is not a normal signal to be transmitted but is noise. Then, the process is fed back to step S404.

If it is judged at step S405 that the correlation value is larger than the threshold value, the maximum correlation value of a current symbol of the input signal is detected, and the position thereof is stored (step S406).

Then, the maximum correlation value of a next symbol, which is applied after the current symbol, is detected, and the position thereof is stored (step S407).

The position of the maximum correlation value of the current symbol, stored at step S406, is subtracted from the position of the maximum correlation value of the next symbol, stored at step S407. Then, it is judged whether the difference in position between the maximum correlation values of the next symbol and the current symbol is equal to the period of one symbol or not (step S408).

When it is judged at step S408 that the difference is equal to the period of one symbol, the count value is increased by 1 (step S410).

When it is judged at step S408 that the difference is not equal to the period of one symbol, the count value is set to 0, and the process is fed back to step S406.

Meanwhile, it is judged whether or not the count value increased at step S410 is equal to the symbol-period count value set at step S402 (step S411).

At this time, when it is judged at step S411 that the count value is not equal to the symbol-period count value, the process is fed back to step S406. The position of the maximum correlation value of a symbol, which is applied after the next symbol, is detected and stored, and steps S406 to S411 are repeated.

When it is judged at step S411 that the count value is equal to the symbol-period count value after steps S406 and S411 are repeated, it is judged that the input signal is a normal signal to be transmitted, and a preamble included in the input signal is searched for. When the preamble is applied, a preamble detection signal for synchronizing packets is generated (step S412).

Data of the input signal, which is applied from a point of time where the preamble detection signal is generated at step S412, is received (step S413).

According to the present invention, packets are synchronized by judging whether a difference in position between the maximum correlation values of the respective symbols of the input signal is equal to the period of one symbol or not. Therefore, a loss generated by noise can be reduced into 0.3% from 12%. Accordingly, sensitivity is enhanced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A synchronization device for wireless communication packets, comprising:
an A/D (analog/digital) converter that converts an analog input signal applied from outside into a digital signal;
a correlation calculating section that is connected to the A/D converter and correlates the converted input signal with a preset reference code so as to calculate a correlation value;
a threshold setting section that is connected to the correlation calculating section and sets a threshold value of the correlation value;
a maximum correlation detecting section that is connected to the correlation calculating section and the threshold setting section, compares the correlation value with the threshold value, detects the position of the maximum correlation value within each symbol of the input signal when the correlation value is larger than the threshold value, and judges whether a difference in position between the maximum correlation values of consecutive symbols is equal to the period of one symbol or not;
a preamble detecting section that is connected to the correlation calculating section and the maximum correlation detecting section and outputs a preamble detection signal when the difference is equal to the period of one symbol; and
a data detecting section that receives data of the input signal when the preamble detection signal is applied.

2. The synchronization device according to claim 1, wherein the maximum correlation detecting section increases a count value by 1, when a difference in position between the maximum correlation values of a current symbol and a next symbol is equal to the period of one symbol.

3. The synchronization device according to claim 2, wherein when the count value is equal to the preset symbol-period count value, the preamble detecting section operates to detect a preamble and outputs a preamble detection signal when the preamble is detected.

4. The synchronization device according to claim 2, wherein when the difference in position between the maximum correlation values of the current symbol and the next symbol is not equal to the period of one symbol, the maximum correlation detecting section sets the count value to 0 and then increases the count value on the basis of the next symbol.

5. A synchronization method for wireless communication packets, comprising the steps of:
(a) setting a threshold value and a symbol-period count value;
(b) converting an analog input signal, applied from outside, into a digital signal;
(c) correlating the converted input signal with a preset reference code so as to calculate a correlation value;
(d) comparing the calculated correlation value with the threshold value, detecting the maximum correlation value of a current symbol of the input signal when the correlation value is larger than the threshold value, and storing the position of the maximum correlation value;
(e) detecting the maximum correlation value of a next symbol of the input signal and storing the position of the maximum correlation value;
(f) judging whether or not a difference in position between the maximum correlation values of the next symbol and the current symbol is equal to the period of one symbol;
(g) when it is judged at step (f) that the difference is equal to the period of one symbol, increasing the count value by 1; and
(h) judging whether or not the increased count value is equal to the symbol-period count value set at step (a), detecting a preamble to generate a preamble detection signal when the count value is equal to the symbol-period count value, and receiving data included in the input signal.

6. The synchronization method according to claim 5, wherein when the calculated correlation value is smaller than the threshold value at step (d), the process is fed back to step (c).

7. The synchronization method according to claim 5, wherein when it is judged at step (f) that the difference in position between the maximum correlation values of the next symbol and the current symbol is not equal to the period of one symbol, the process is fed back to step (d).

8. The synchronization method according to claim 7, wherein when the process is fed back to step (d), the count value is set to 0.

9. The synchronization method according to claim 7, wherein after the process is fed back to step (d), the position of the maximum correlation value of a symbol, applied after the next symbol, is compared with the position of the maximum correlation value of the next symbol.

10. The synchronization method according to claim 5, wherein when it is judged at step (h) that the count value is not equal to the symbol-period count value, the process is fed back to step (d) and is then repeated.
